(19) United States
(12) Patent Application Publication
(10) Pub. No.: US 2026/0146559 A1
(43) Pub. Date: May 28, 2026

(54) SOUNDPROOF DEVICE FOR DUCT AND INTAKE DUCT FOR COMPRESSOR OF GAS TURBINE

(71) Applicant: MITSUBISHI HEAVY INDUSTRIES, LTD., Tokyo (JP)

(72) Inventors: Tomohiro GOTO, Tokyo (JP); Keizo OHNISHI, Tokyo (JP); Yuki MITSUI, Tokyo (JP)

(21) Appl. No.: 19/384,111

(22) Filed: Nov. 10, 2025

(30) Foreign Application Priority Data
Nov. 26, 2024 (JP) 2024-205305

(51) Int. Cl. F02C 7/045

(52) U.S. Cl. CPC F02C 7/045; F05D 2260/96

(57) ABSTRACT

A soundproof device for a duct including: a first sound absorbing material disposed on one side of an outer wall member of the duct; a second sound absorbing material disposed on the other side of the outer wall; a first fixing member to fix the first sound absorbing material to the outer wall member; a first plate member covering the first sound absorbing material from the one side and fixed to the first fixing member; and a second plate member covering the second sound absorbing material from the other side and fixed to the outer wall member via a shaft member. The first fixing member has a connection portion where the first fixing member and the outer wall member are connected and a non-connection portion where the first fixing member and the outer wall member are not connected, being arranged alternately along an extension direction of the first fixing member.

### TECHNICAL FIELD

The present disclosure relates to a soundproof device for a duct and an intake duct for a compressor of a gas turbine.

The present application claims priority based on Japanese Patent Application No. 2024-205305 filed on Nov. 26, 2025, the entire content of which is incorporated herein by reference.

### BACKGROUND ART

Ducts through which fluid flows may be required to have a function to reduce noise and vibration from upstream and downstream of the fluid flow. For this reason, some ducts are equipped with sound absorbing materials (see, for example, Patent Document 1).

The duct described in Patent Document 1 is an intake duct for directing intake air to a compressor of a gas turbine, and a sound absorbing material is provided in the intake duct to reduce the transmission of the air intake sound generated by the compressor to the outside.

### CITATION LIST

### Patent Literature

Patent Document 1: JP2014-190253A

### SUMMARY

In recent years, the air intake noise generated by compressors has tended to increase due to the increasing size of gas turbines. In addition, there is a need to meet stricter standards for noise due to environmental regulations, etc., and it is desirable to improve the soundproof performance of ducts.

In view of the above, an object of at least one embodiment of the present disclosure is to provide a soundproof device for a duct and an intake duct for a compressor of a gas turbine whereby it is possible to improve the soundproof performance of the duct.

(1) A soundproof device for a duct according to at least one embodiment of the present disclosure is provided with: a first sound absorbing material disposed on one side of an outer wall member of the duct in a thickness direction of the outer wall member; a second sound absorbing material disposed on the other side of the outer wall member in the thickness direction; a first fixing member extending in a direction perpendicular to the thickness direction to fix the first sound absorbing material to the outer wall member; a first plate member covering the first sound absorbing material from the one side and fixed to the first fixing member; and a second plate member covering the second sound absorbing material from the other side and fixed to the outer wall member via a shaft member. The first fixing member has a connection portion where the first fixing member and the outer wall member are connected and a non-connection portion where the first fixing member and the outer wall member are not connected, the connection portion and the non-connection portion being arranged alternately along an extension direction of the first fixing member.

(2) An intake duct for a compressor of a gas turbine according to at least one embodiment of the present disclosure is provided with a duct with the soundproof device having the above configuration (1) arranged such that a surface of the first plate member on the one side forms an inner surface of the intake duct.

According to at least one embodiment of the present disclosure, it is possible to improve the soundproof performance of the duct.

### BRIEF DESCRIPTION OF DRAWINGS

FIG. 1 is a schematic diagram showing the overall configuration of a gas turbine.

FIG. 2 is a cross-sectional view taken along line II-II in FIG. 1.

FIG. 3 is a cross-sectional view taken along line III-III in FIG. 2.

FIG. 4 is an enlarged view of section A in FIG. 2.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

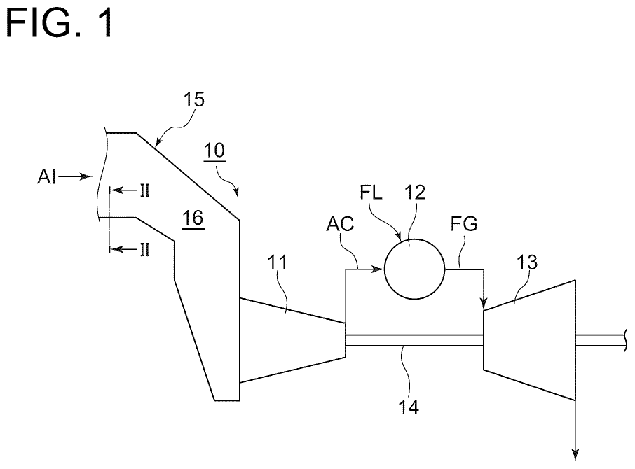

FIG. 1 is a schematic diagram showing the overall configuration of a gas turbine.

In the present embodiment, as shown in FIG. 1, a gas turbine 10 has an intake duct 15 and is configured such that a compressor 11, a combustor 12, and a turbine 13 are arranged coaxially on a rotor 14, and the rotor 14 is coupled at one end to a generator (not shown).

The compressor 11 generates high-temperature/high-pressure compressed air AC by compressing air AI taken in through the intake duct 15 from the air inlet as it passes through a plurality of stator vanes and rotor blades. The combustor 12 generates high-temperature/high-pressure combustion gas FG by supplying a predetermined fuel FL to the compressed air AC and burning the mixture. The turbine 13 drives the rotor 14 to rotate as the working fluid, the high-temperature/high-pressure combustion gas FG generated by the combustor 12, passes through a plurality of stator vanes and rotor vanes, thereby driving the generator (not shown) coupled to the rotor 14.

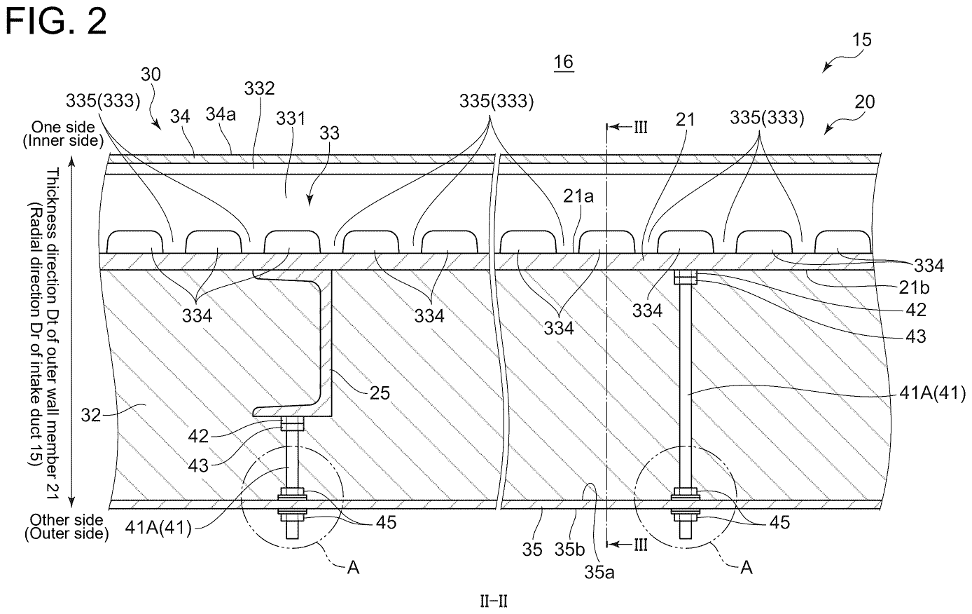

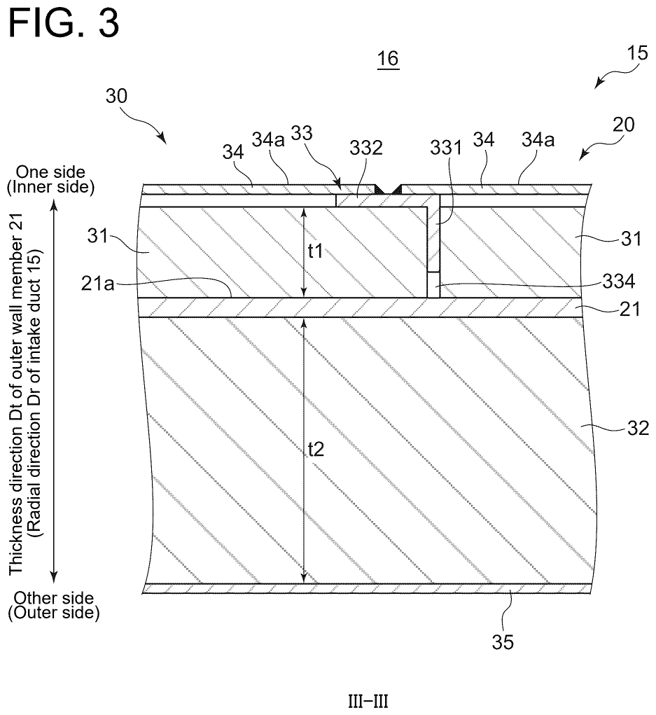

The intake duct 15 according to an embodiment is formed by combining a plurality of flat duct panels 20, including an outer wall member 21 and a soundproof device 30, which will be described below, provided in the outer wall member 21 as shown in FIGS. 2 and 3.

FIG. 2 is a cross-sectional view taken along line II-II in FIG. 1 and shows a cross-section of the duct panel 20.

FIG. 3 is a cross-sectional view taken along line III-III in FIG. 2 and shows a cross-section of the duct panel 20.

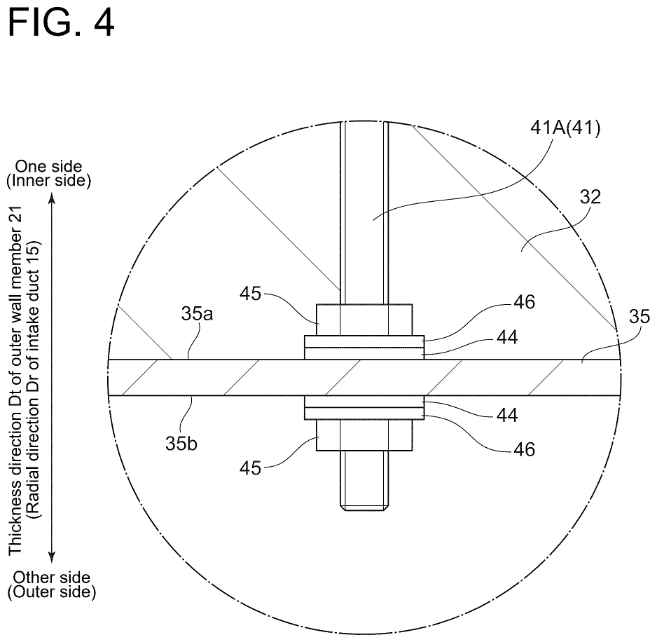

FIG. 4 is an enlarged view of section A in FIG. 2.

The soundproof device 30 for the intake duct 15 according to an embodiment is provided with: a first sound absorbing material 31 (see FIG. 3) disposed on one side of the outer wall member 21 in the thickness direction Dt of the outer wall member 21; a second sound absorbing material 32 disposed on the other side of the outer wall member 21 in the thickness direction Dt; a first fixing member 33 extending in a direction perpendicular to the thickness direction Dt to fix the first sound absorbing material 31 to the outer wall member 21; a first plate member 34 covering the first sound absorbing material 31 from one side and fixed to the first fixing member 33; and a second plate member 35 covering the second sound absorbing material 32 from the other side and fixed to the outer wall member 21 via a shaft member 41.

In FIG. 2, the first sound absorbing material 31 is not depicted for the sake of descriptive convenience.

In the intake duct 15 according to an embodiment, the outer wall member 21 is a plate-like member extending in a direction perpendicular to the thickness direction Dt of the outer wall member 21, i.e., in a direction perpendicular to the thickness direction Dt along the plane of FIG. 2 and in the depth direction of the drawing. For the sake of descriptive convenience, the inner side in the radial direction Dr, which is centered on the flow direction of air AI in an air passage 16 inside the intake duct 15 (the extension direction of the intake duct 15), is defined as one side in the thickness direction Dt of the outer wall member 21, and the outer side in the radial direction Dr is defined as the other side in the thickness direction Dt.

In the intake duct 15 according to an embodiment, the air passage 16 is, for example, rectangular in cross-section perpendicular to the flow direction of air AI.

### Outer Wall Member 21 and Reinforcement Member 25

In the intake duct 15 according to an embodiment, the outer wall member 21 has a reinforcement member 25 attached to the other side of the outer wall member 21 in the thickness direction Dt and extending in a direction perpendicular to the thickness direction Dt.

In the example shown in FIG. 2, the reinforcement member 25 extends in the depth direction of FIG. 2, but it may extend in a direction different from the depth direction of FIG. 2 as long as it is perpendicular to the thickness direction Dt.

In the example shown in FIG. 2, the reinforcement member 25 has a C-shaped cross-section when viewed in the extension direction of the reinforcement member 25; however, shapes other than C-shaped, such as L-shaped, may also be used.

Although only one reinforcement member 25 is illustrated in FIG. 2, a plurality of reinforcement members 25 may be attached to the outer wall member 21 of one duct panel 20. The extension directions of the plurality of reinforcement members 25 may be the same or different.

### First Fixing Member 33

In the soundproof device 30 according to an embodiment, the first fixing member 33 is attached to one side of the outer wall member 21 in the thickness direction Dt and extends in a direction perpendicular to the thickness direction Dt.

In the example shown in FIG. 2, the first fixing member 33 extends in a direction perpendicular to the thickness direction Dt along the plane of FIG. 2, but it may extend in a direction different from the direction perpendicular to the thickness direction Dt along the plane of FIG. 2 as long as it is perpendicular to the thickness direction Dt.

Although only one first fixing member 33 is illustrated in FIGS. 2 and 3, a plurality of first fixing members 33 may be attached to the outer wall member 21 of one duct panel 20. The extension directions of the plurality of first fixing members 33 may be the same or different.

The first fixing member 33 according to an embodiment includes a plate-like first part 331 extending in the thickness direction Dt.

The first fixing member 33 according to an embodiment may include a second part 332 that protrudes, in a direction (the left-right direction of FIG. 3) perpendicular to both the extension direction of the first fixing member 33 (the depth direction of FIG. 3) and the thickness direction Dt, from an end portion of the first part 331 on one side in the thickness direction Dt of both end portions in the thickness direction Dt, as shown in FIG. 3, for example.

In the example shown in FIG. 3, the second part 332 protrudes from the end portion of the first part 331 on one side in the thickness direction Dt toward one side (the left side of FIG. 3) in the direction (the left-right direction of FIG. 3) perpendicular to the thickness direction Dt, but it may also protrude toward the other side (the right side of FIG. 3) in the direction (the left-right direction of FIG. 3) perpendicular to the thickness direction Dt. That is, the first fixing member 33 according to an embodiment may be L-shaped as shown in FIG. 3, or T-shaped in cross-section when viewed in the extension direction of the first fixing member 33.

In the first fixing member 33 according to an embodiment, the first part 331 has a connection portion 333 where the first fixing member 33 (first part 331) and the outer wall member 21 are connected and a non-connection portion 334 where the first fixing member 33 (first part 331) and the outer wall member 21 are not connected, which are arranged alternately along the extension direction of the first fixing member 33 (the direction perpendicular to the thickness direction Dt along the plane of FIG. 2, the depth direction of FIG. 3).

The first fixing member 33 according to an embodiment is fixed to the surface 21a of the outer wall member 21 on one side in the thickness direction Dt at the connection portion 333, for example, by welding.

In the first fixing member 33 according to an embodiment, the connection portion 333 is a plurality of projections 335 arranged on the first fixing member 33 (first part 331) at intervals along the extension direction of the first fixing member 33 (the direction perpendicular to the thickness direction Dt along the plane of FIG. 2, the depth direction of FIG. 3) and protruding toward the other side in the thickness direction Dt.

The pitch of arrangement of the connection portions 333 along the extension direction of the first fixing member 33 may be uniform or non-uniform. The dimensions of the connection portions 333 along the extension direction of the first fixing member 33 may be the same or different for each connection portion 333.

The projections 335, i.e., the connection portions 333, and the first part 331 on one side of the connection portions 333 in the thickness direction Dt may have the same dimension in the depth direction of FIG. 2 (the left-right direction of FIG. 3), or the connection portions 333 may be smaller than the first part 331 on one side of the connection portions 333 in the thickness direction Dt.

### First Sound Absorbing Material 31

In the soundproof device 30 according to an embodiment, the first sound absorbing material 31 is disposed on one side of the outer wall member 21 in the thickness direction Dt of the outer wall member 21, as described above, and is fixed by the first fixing member 33. In other words, the first sound absorbing material 31 is restricted from moving in a direction perpendicular to the thickness direction Dt by the first fixing member 33, and from moving in the thickness direction Dt by the first plate member 34, which is fixed to the first fixing member 33 as described below, and the outer wall member 21.

The dimension of the first sound absorbing material 31 in the thickness direction Dt, i.e., thickness t1 of the first sound absorbing material 31, is smaller than the dimension of the second sound absorbing material 32 in the thickness direction Dt, i.e., thickness t2 of the second sound absorbing material 32, which will be described below.

### First Plate Member 34

In the soundproof device 30 according to an embodiment, the first plate member 34 is a plate-like member extending in a direction perpendicular to the thickness direction Dt, i.e., in a direction perpendicular to the thickness direction Dt along the plane of FIG. 2 and in the depth direction of the drawing. As well shown in FIG. 3, the first plate member 34 covers the first sound absorbing material 31 from one side in the thickness direction Dt as described above. The first plate member 34 is fixed, for example at its edge, to the second part 332 of the first fixing member 33, for example, by welding.

### Second Sound Absorbing Material 32

In the soundproof device 30 according to an embodiment, the second sound absorbing material 32 is disposed on the other side of the outer wall member 21 in the thickness direction Dt, as described above. The second sound absorbing material 32 is restricted from moving in the thickness direction Dt by the second plate member 35, which will be described below, and the outer wall member 21. Additionally, the second sound absorbing material 32 is restricted from moving in a direction perpendicular to the thickness direction Dt by the reinforcement member 25 and the shaft member 41, which will be described below.

### Second Plate Member 35

In the soundproof device 30 according to an embodiment, the second plate member 35 is a plate-like member extending in a direction perpendicular to the thickness direction Dt, i.e., in a direction perpendicular to the thickness direction Dt along the plane of FIG. 2 and in the depth direction of the drawing. The second plate member 35 covers the second sound absorbing material 32 from the other side in the thickness direction Dt as described above.

The second plate member 35 is directly fixed to the outer wall member 21 via the shaft member 41. Further, the second plate member 35 is directly fixed to the outer wall member 21 via the shaft member 41 and the reinforcement member 25.

Specifically, for example, as shown in the right area of FIG. 2, an end portion of the shaft member 41, such as a stud bolt 41A, on one side in the thickness direction Dt is fixed to the outer wall member 21 by so-called double-nut fastening with one nut 42 fixed, for example by welding, to an end surface 21b of the outer wall member 21 on the other side in the thickness direction Dt and another nut 43. Also, for example, as shown in the left area of FIG. 2, an end portion of the shaft member 41, such as a stud bolt 41A, is fixed to the outer wall member 21 by so-called double-nut fastening with one nut 42 fixed, for example by welding, to an end portion of the reinforcement member 25 on the other side in the thickness direction Dt and another nut 43.

For example, as shown in FIG. 4, on the other side in the thickness direction Dt of the shaft member 41, which is directly or indirectly fixed to the outer wall member 21 as described above, the second plate member 35 is fixed to the shaft member 41 by nuts 45 via elastic members on both a surface 35a on one side in the thickness direction Dt and a surface 35b on the other side in the thickness direction Dt. In other words, the second plate member 35 is sandwiched between washers 44 made of elastic material that can absorb vibration, such as rubber, on the surface 35a on one side in the thickness direction Dt and the surface 35b on the other side in the thickness direction Dt. The second plate member 35 is further sandwiched between a nut 45 disposed on one side of the washer 44 on one side in the thickness direction Dt and a nut 45 disposed on the other side of the washer 44 on the other side in the thickness direction Dt, thereby being fixed to the shaft member 41 via the elastic members.

A metal washer 46 may be disposed between the washer 44, which is made of elastic material, and the nut 45.

The shaft member 41 may be a bolt with a head instead of the stud bolt 41A as described above. If the shaft member 41 is a head bolt, the head of the bolt should be fixed to the end surface 21b of the outer wall member 21 on the other side in the thickness direction Dt, for example, by welding.

In the soundproof device 30 according to an embodiment with this configuration, noise and vibration (hereinafter referred to as vibration, etc.) from one side to the other side in the thickness direction Dt is first transmitted to the first plate member 34 from the area on one side of the first plate member 34 in the thickness direction Dt. In the case where the soundproof device 30 according to an embodiment is used for the intake duct 15, vibration, etc., from one side to the other side in the thickness direction Dt is first transmitted from the air passage 16 to the first plate member 34.

Vibration, etc., reaching the first plate member 34 is transmitted to the outer wall member 21 while being attenuated by the first sound absorbing material 31.

Also, vibration, etc., reaching the first plate member 34 is transmitted to the outer wall member 21 via the first fixing member 33. In this case, vibration, etc., transmitted from the first fixing member 33 to the outer wall member 21 is transmitted from the connection portion 333 in the first part 331 of the first fixing member 33 to the outer wall member 21. In the soundproof device 30 according to an embodiment, since the first part 331 of the first fixing member 33 has alternating connection portions 333 and non-connection portions 334 along the extension direction of the first fixing member 33, the transmission of vibration, etc., between the first fixing member 33 and the outer wall member 21 is reduced, so that the vibration, etc., transmitted in the thickness direction Dt of the outer wall member 21 is effectively reduced.

In the soundproof device 30 according to an embodiment, as described above, the connection portion 333 of the first fixing member 33 is a plurality of projections 335 arranged on the first fixing member 33 (first part 331) at intervals along the extension direction of the first fixing member 33 and protruding toward the other side in the thickness direction Dt.

This allows the transmission of vibration, etc., between the first fixing member 33 and the outer wall member 21 to be reduced by a relatively simple configuration, effectively reducing the vibration, etc., transmitted in the thickness direction Dt of the outer wall member 21.

Additionally, in the soundproof device 30 according to an embodiment, since the first fixing member 33 is fixed to the outer wall member 21 at the plurality of connection portions 333, which are the plurality of projections 335 protruding toward the other side in the thickness direction Dt, it is possible to effectively reduce the possibility of the first fixing member 33 detaching from the outer wall member 21.

For example, in the case where the soundproof device 30 according to an embodiment is used for the intake duct 15, if the first fixing member 33 were to detach from the outer wall member 21, the first fixing member 33, the first plate member 34, or the first sound absorbing material 31 would enter the compressor 11, causing damage to the compressor 11.

In this regard, the soundproof device 30 according to an embodiment effectively reduces the possibility of the first fixing member 33 detaching from the outer wall member 21 as described above, thus reducing the possibility of damage to the compressor 11.

In the soundproof device 30 according to an embodiment, since the reinforcement member 25 is attached to the other side of the outer wall member 21 in the thickness direction Dt and extends in a direction perpendicular to the thickness direction Dt, the outer wall member 21 is effectively reinforced.

For example, in the case where the soundproof device 30 according to an embodiment is used for the intake duct 15, the reinforcement member 25 can effectively reinforce the intake duct 15.

Additionally, in the case where the soundproof device 30 according to an embodiment is used for the intake duct 15, the reinforcement member 25 is attached to the other side of the outer wall member 21 in the thickness direction, Dt, i.e., the outer side in the radial direction Dr of the intake duct 15. Therefore, compared to the case where the reinforcement member 25 is attached to the inner side of the outer wall member 21 in the radial direction Dr of the intake duct 15, it is easier to secure the cross-sectional area of the air passage 16, thus reducing the effect on the intake air volume.

In the soundproof device 30 according to an embodiment, since the dimension (thickness t1) of the first sound absorbing material 31 in the thickness direction Dt is smaller than the dimension (thickness t2) of the second sound absorbing material 32 in the thickness direction Dt, the dimension from the outer wall member 21 to one side in the thickness direction Dt can be reduced.

For example, in the case where the soundproof device 30 according to an embodiment is used for the intake duct 15, the dimension from the outer wall member 21 to the inner side in the radial direction Dr of the intake duct 15 can be reduced. This makes it easier to secure the cross-sectional area of the air passage 16, thus reducing the effect on the intake air volume.

In the soundproof device 30 according to an embodiment, the shaft member 41 may be a bolt that passes through the second plate member 35 in the thickness direction Dt. This bolt may be a stud bolt 41A, as described above, or a bolt with a head. The second plate member 35 may be fixed to the shaft member 41 by nuts 45 via elastic members on both the surface 35a on one side and the surface 35b on the other side in the thickness direction Dt.

This reduces vibration, etc. transmitted from the outer wall member 21 to the second plate member 35 via the shaft member 41.

Thus, with the soundproof device 30 according to an embodiment, since the first sound absorbing material 31 and the second sound absorbing material 32 are disposed on opposite sides of the outer wall member 21, the noise and vibration transmitted in the thickness direction Dt of the outer wall member 21 is effectively reduced.

Additionally, with the soundproof device 30 according to an embodiment, since the connection portion 333 and the non-connection portion 334 are arranged alternately along the extension direction of the first fixing member 33, as described above, the transmission of vibration, etc., between the first fixing member 33 and the outer wall member 21 is reduced, so that the vibration, etc., transmitted in the thickness direction Dt of the outer wall member 21 is effectively reduced.

The intake duct 15 according to an embodiment is an intake duct 15 in which the soundproof device 30 according to the above-described embodiments is arranged such that a surface 34a of the first plate member 34 on one side in the thickness direction Dt forms the inner surface of the intake duct 15 in the radial direction Dr.

This effectively reduces the transmission of the air intake sound generated by the compressor 11 to the outside.

The present disclosure is not limited to the embodiments described above, but includes modifications to the embodiments described above, and embodiments composed of combinations of those embodiments.

For example, the example in which the soundproof device 30 according to the above-described embodiments is applied to the intake duct 15 of the compressor 11 of the gas turbine 10 has been described, but the soundproof device 30 according to the above-described embodiments may be applied to a duct other than the intake duct 15 of the compressor 11 of the gas turbine 10. For example, the soundproof device 30 according to an embodiment may be applied to an exhaust duct of the turbine 13 of the gas turbine 10. Alternatively, the soundproof device 30 according to an embodiment may be applied to an air conditioning duct, for example.

The contents described in the above embodiments would be understood as follows, for instance.

(1) A soundproof device 30 for a duct according to at least one embodiment of the present disclosure is provided with: a first sound absorbing material 31 disposed on one side of an outer wall member 21 of the duct (intake duct 15) in the thickness direction Dt of the outer wall member 21; a second sound absorbing material 32 disposed on the other side of the outer wall member 21 in the thickness direction Dt; a first fixing member 33 extending in a direction perpendicular to the thickness direction Dt to fix the first sound absorbing material 31 to the outer wall member 21; a first plate member 34 covering the first sound absorbing material 31 from the one side and fixed to the first fixing member 33; and a second plate member 35 covering the second sound absorbing material 32 from the other side and fixed to the outer wall member 21 via a shaft member 41. The first fixing member 33 has a connection portion 333 where the first fixing member 33 and the outer wall member 21 are connected and a non-connection portion 334 where the first fixing member 33 and the outer wall member 21 are not connected, the connection portion 333 and the non-connection portion 334 being arranged alternately along the extension direction of the first fixing member 33.

With the above configuration (1), since the first sound absorbing material 31 and the second sound absorbing material 32 are disposed on opposite sides of the outer wall member 21, the noise and vibration transmitted in the thickness direction Dt of the outer wall member 21 is effectively reduced. Additionally, with the above configuration (1), since the connection portion 333 and the non-connection portion 334 are alternately arranged along the extension direction of the first fixing member 33, the transmission of noise and vibration between the first fixing member 33 and the outer wall member 21 is reduced, so that the noise and vibration transmitted in the thickness direction Dt of the outer wall member 21 is effectively reduced.

(2) In some embodiments, in the above configuration (1), the connection portion 333 may be a plurality of projections 335 arranged on the first fixing member 33 at intervals along the extension direction and protruding toward the other side.

With the above configuration (2), the transmission of noise and vibration between the first fixing member 33 and the outer wall member 21 is reduced by a relatively simple configuration, so that the noise and vibration transmitted in the thickness direction Dt of the outer wall member 21 is effectively reduced.

(3) In some embodiments, in the above configuration (1) or (2), the soundproof device may be provided with a reinforcement member 25 attached to the other side of the outer wall member 21 and extending in the perpendicular direction.

With the above configuration (3), the outer wall member 21 is effectively reinforced.

(4) In some embodiments, in any one of the above configurations (1) to (3), a dimension (thickness t1) of the first sound absorbing material 31 in the thickness direction Dt may be smaller than a dimension (thickness t2) of the second sound absorbing material 32 in the thickness direction Dt.

With the above configuration (4), it is possible to reduce the dimension from the outer wall member 21 to the one side. When the soundproof device 30 with the configuration (4) is arranged such that the one side faces the inside of the duct, it is easier to secure the cross-sectional area of the flow path for fluid flowing in the duct, thus reducing the effect on the flow rate of the fluid flowing in the duct.

(5) In some embodiments, in any one of the above configurations (1) to (4), the shaft member 41 may be a bolt (stud bolt 41A) that passes through the second plate member 35 in the thickness direction Dt. The second plate member 35 may be fixed to the shaft member 41 by nuts 45 via elastic members (washers 44) on both a surface 35a on one side and a surface 35b on the other side.

With the above configuration (5), the noise and vibration transmitted from the outer wall member 21 to the second plate member 35 via the bolts (stud bolts 41A) can be reduced.

(6) An intake duct 15 for a compressor 11 of a gas turbine 10 according to at least one embodiment of the present disclosure is provided with a duct (intake duct 15) with the soundproof device 30 having any one of the configurations (1) to (5) arranged such that a surface 34a of the first plate member 34 on the one side forms an inner surface of the intake duct 15.

With the above configuration (6), it is possible to effectively reduce the transmission of the air intake sound from the compressor 11 to the outside.

1. A soundproof device for a duct, comprising:
a first sound absorbing material disposed on one side of an outer wall member of the duct in a thickness direction of the outer wall member;
a second sound absorbing material disposed on the other side of the outer wall member in the thickness direction;
a first fixing member extending in a direction perpendicular to the thickness direction to fix the first sound absorbing material to the outer wall member;
a first plate member covering the first sound absorbing material from the one side and fixed to the first fixing member; and
a second plate member covering the second sound absorbing material from the other side and fixed to the outer wall member via a shaft member,
wherein the first fixing member has a connection portion where the first fixing member and the outer wall member are connected and a non-connection portion where the first fixing member and the outer wall member are not connected, the connection portion and the non-connection portion being arranged alternately along an extension direction of the first fixing member.

2. The soundproof device for the duct according to claim 1,
wherein the connection portion is a plurality of projections arranged on the first fixing member at intervals along the extension direction and protruding toward the other side.

3. The soundproof device for the duct according to claim 1, comprising a reinforcement member attached to the other side of the outer wall member and extending in the perpendicular direction.

4. The soundproof device for the duct according to claim 1,
wherein a dimension of the first sound absorbing material in the thickness direction is smaller than a dimension of the second sound absorbing material in the thickness direction.

5. The soundproof device for the duct according to claim 1,
wherein the shaft member is a bolt that passes through the second plate member in the thickness direction, and
wherein the second plate member is fixed to the shaft member by nuts via elastic members on both a surface on the one side and a surface on the other side.

6. An intake duct for a compressor of a gas turbine, comprising
a duct with the soundproof device according to claim 1 arranged such that a surface of the first plate member on the one side forms an inner surface of the intake duct.
